(19) United States
(12) Patent Application Publication
(10) Pub. No.: US 2019/0050060 A1
(43) Pub. Date: Feb. 14, 2019

(54) METHODS, SYSTEMS, AND MEDIA FOR PROVIDING INPUT BASED ON ACCELEROMETER INPUT

(71) Applicant: Awearable Apparel Inc., Brooklyn, NY (US)

(72) Inventors: Justin Lange, Brooklyn, NY (US); John Michael De Cristofaro, Brooklyn, NY (US); Abhishek Vishwakarma, Harrison, NJ (US)

(21) Appl. No.: 15/915,693

(22) Filed: Mar. 8, 2018

Related U.S. Application Data
(60) Provisional application No. 62/469,964, filed on Mar. 10, 2017.

(51) Int. Cl. G06F 3/01; G06F 3/0482; G06F 3/0485; G06F 3/02

(52) U.S. Cl. CPC G06F 3/017; G06F 3/02; G06F 3/0485; G06F 3/0482

(57) ABSTRACT

Methods, systems, and media for providing input are provided. In some embodiments, the method comprises: causing a user interface for selecting an item to be presented on a user device, wherein the user interface indicates a group of available items; receiving a first input from an accelerometer associated with the user device; updating the user interface based on the first input from the accelerometer to highlight one item from the group of available items; receiving a second input from the user device indicating that the highlighted item is to be selected; storing the selected item; and updating the user interface to indicate the selected item.

### CROSS-REFERENCE TO RELATED APPLICATION

This application claims the benefit of U.S. Provisional Patent Application No. 62/469,964, filed Mar. 10, 2017, which is hereby incorporated by reference herein in its entirety.

### TECHNICAL FIELD

The disclosed subject matter relates to methods, systems, and media for providing input based on accelerometer input.

### BACKGROUND

Many people use small, wearable devices, such as fitness trackers, watches, or other small devices. These devices often request that information be entered, such as information about the user (e.g., a name, etc.) However, it can be difficult to enter information using a small device.

Accordingly, it is desirable to provide methods, systems, and media for providing input based on accelerometer input.

### SUMMARY

Methods, systems, and media for providing input based on accelerometer input are provided. In accordance with some embodiments of the disclosed subject matter, a method for providing input is provided, the method comprising: causing a user interface for selecting an item to be presented on a user device, wherein the user interface indicates a group of available items; receiving a first input from an accelerometer associated with the user device; updating the user interface based on the first input from the accelerometer to highlight one item from the group of available items; receiving a second input from the user device indicating that the highlighted item is to be selected; storing the selected item; and updating the user interface to indicate the selected item.

In accordance with some embodiments of the disclosed subject matter, a system for providing input is provided, the system comprising: a memory; and a hardware processor coupled to the memory that is configured to: cause a user interface for selecting an item to be presented on a user device, wherein the user interface indicates a group of available items; receive a first input from an accelerometer associated with the user device; update the user interface based on the first input from the accelerometer to highlight one item from the group of available items; receive a second input from the user device indicating that the highlighted item is to be selected; store the selected item; and update the user interface to indicate the selected item.

In accordance with some embodiments of the disclosed subject matter, a non-transitory computer-readable medium containing computer executable instructions that, when executed by a processor, cause the processor to perform a method for providing input is provided, the method comprising: causing a user interface for selecting an item to be presented on a user device, wherein the user interface indicates a group of available items; receiving a first input from an accelerometer associated with the user device; updating the user interface based on the first input from the accelerometer to highlight one item from the group of available items; receiving a second input from the user device indicating that the highlighted item is to be selected; storing the selected item; and updating the user interface to indicate the selected item.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIGS. 1A and 1B show examples of user interfaces for providing input in accordance with some embodiments of the disclosed subject matter.

FIG. 2 shows an example of a process for providing input on a user device in accordance with some embodiments of the disclosed subject matter.

FIG. 3 shows a detailed example of hardware that can be used in a user device in accordance with some embodiments of the disclosed subject matter.

### DETAILED DESCRIPTION

In accordance with various embodiments, mechanisms (which can include methods, systems, and media) for providing input based on accelerometer input are provided.

In some embodiments, the mechanisms described herein can present a user interface for providing input for the user interface using input from an accelerometer and/or a magnetometer. For example, in some embodiments, the user interface can indicate a group of characters available for selection, and a character from the group of characters can be highlighted in response to determining that the user device has been tilted in a particular direction based on input from the accelerometer. A user of the user device can tilt the user device in different directions to scroll through the group of available characters until a desired character is highlighted. The highlighted character can then be selected via the user interface. In some embodiments, multiple characters can be selected in this manner, for example, to provide information in response to a prompt (e.g., to enter a name of a user of the user device, to enter a username or password, and/or to enter any other suitable information). Note that, although the mechanisms described herein are generally described as used for selecting one or more characters from a group of characters, in some embodiments, the mechanisms described herein can allow a user to select an item from any other suitable group of items, such as selecting a term from a group of terms, selecting an image from a group of images, and/or selecting any other suitable type of item via the user interface. As a more particular example, in some embodiments, the mechanisms described herein can present a group of terms (e.g., geographic locations such as names of cities or states, various age ranges, and/or any other suitable groups of terms) and use input from the accelerometer to scroll through terms in the group of terms.

In some embodiments, the mechanisms can cause the characters to scroll in the user interface at different speeds based on input from the accelerometer. For example, in some embodiments, determining that the user device has been tilted in a particular direction at a relatively large degree of tilt can cause the characters to scroll at a relatively faster speed compared to if the user device is tilted to a smaller degree.

Note that, although input used to select items via the user interface is generally described herein as received from an accelerometer, in some embodiments, the input can come from any other suitable sensor or input device. For example, in some embodiments, input can be received via a sensor such as an eye-tracking device or head-motion detection device, received via an attached input device such as a steering wheel or joystick, and/or from any other suitable sensor or input device. As another example, in some embodiments, the input can be received via a magnetometer. Additionally, in some embodiments, input from a sensor can indicate rotation around any suitable number (e.g., one, two, and/or three) axes. For example, in some embodiments, rotation around three axes (e.g., pitch, roll, and yaw) can control scrolling of the items in the user interface. As another example, in some embodiments, rotation around one axis can control scrolling of the items in the user interface. As a more particular example, a rotation around a single axis such as the motion of turning a steering wheel, can control scrolling of the items in the user interface. As a specific example, in instances where rotation around a single axis control scrolling of the items in the user interface, an angular position indicated by the input sensor (e.g., indicating a rotation of the device around the axis) can be used to select a highlighted character within the user interface.

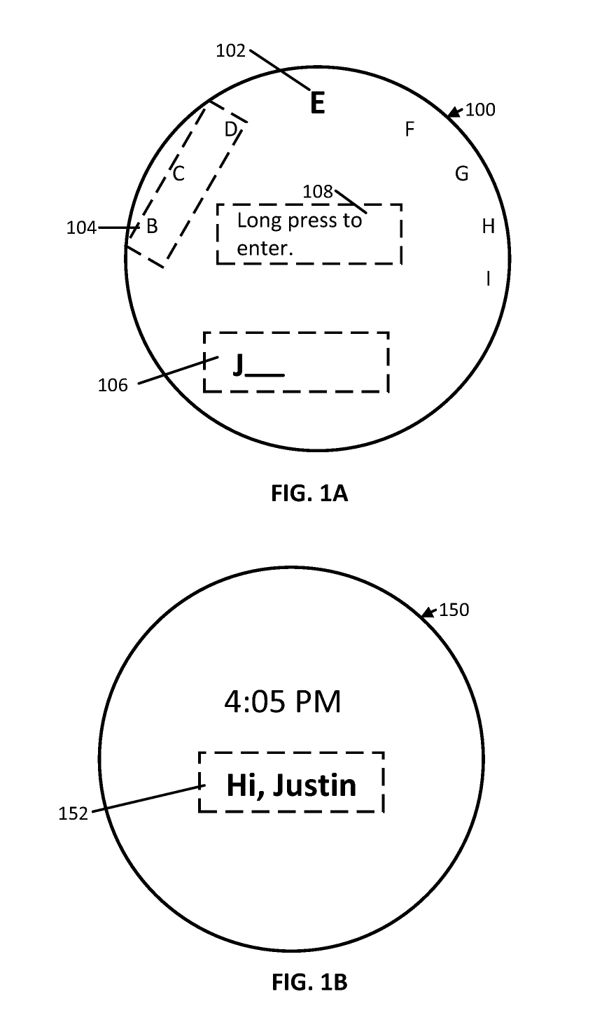

Turning to FIG. 1A, an example 100 of a user interface for allowing a user to provide input is shown in accordance with some embodiments of the disclosed subject matter. As illustrated, in some embodiments, user interface 100 can include a highlighted character 102, available characters 104, selected characters 106, and/or instructions 108. Note that, in some embodiments, any suitable characters (e.g., letters, numbers, punctuation characters, and/or any other suitable types of characters) can be selected via user interface 100.

In some embodiments, highlighted character 102 can indicate a character that is currently indicated for selection based on a position or current movement of the user device. For example, in some embodiments, highlighted character 102 can be a character that, if selected (e.g., by selection of a particular button as indicated by instructions 108), would be stored in selected characters 106.

In some embodiments, available characters 104 can be one or more characters that are available to become highlighted character 102 if a position or current movement of the user device is changed in a particular manner. For example, in some embodiments, each of available characters 104, shown to the left of highlighted character 102, can become highlighted character 102 in response to determining that a user of the user device has tilted the user device to the left. As another example, characters to the right of highlighted character 102 can become highlighted character 102 in response to determining that a user of the user device has tilted the user device to the right. Note that, although the available characters are arranged in a semi-circle around highlighted character 102 in user interface 100, in some embodiments, the available characters can be arranged in any suitable format. For example, in some embodiments, the available characters can be arranged in rows and/or columns above or below highlighted character 102, as a horizontal or vertical shelf around highlighted character 102, and/or in any other suitable manner. Note that, in some embodiments, available characters 104 can represent a subset of a group of available characters. For example, in instances where the group of available characters includes 26 letters of the English alphabet, available characters 104 can represent any suitable subset (e.g., 10 letters, and/or any other suitable number).

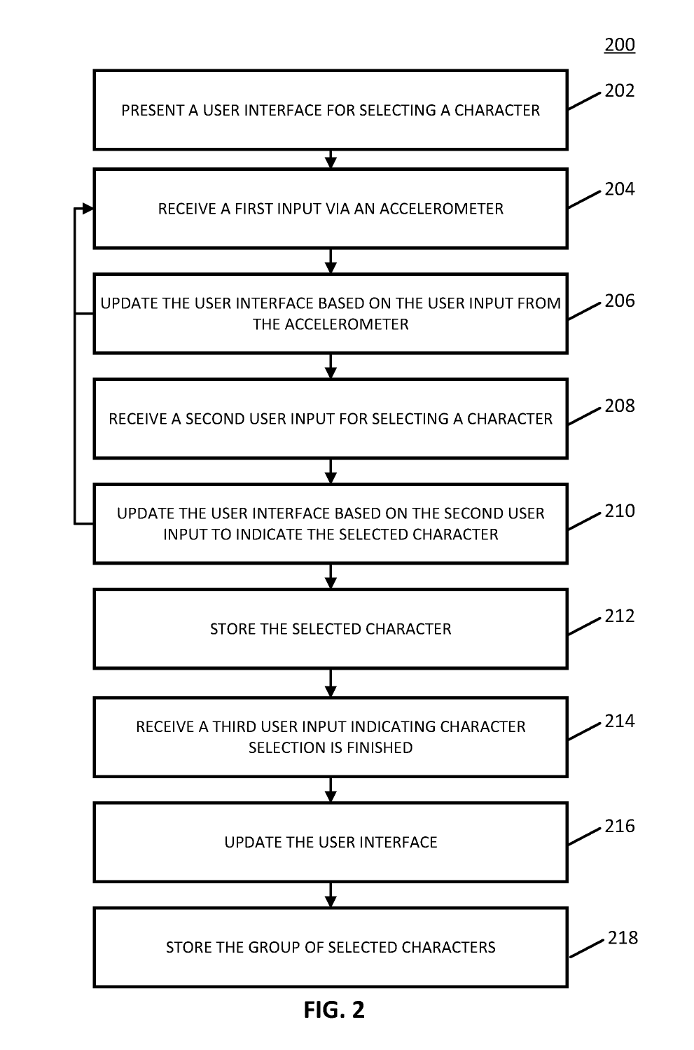

In some embodiments, the characters included in available characters 104 can be updated or modified at any suitable time and based on any suitable information, for example, based on input from an accelerometer associated with the user device, as shown in and described below in connection with block 204. For example, as described below in connection with FIG. 2, input from the accelerometer can cause characters presented in user interface 100 to scroll in particular direction (e.g., clockwise, counterclockwise, to the right, to the left, up, down, and/or scroll in any other suitable manner).

In some embodiments, selected characters 106 can be characters that have been selected by the user. For example, in some embodiments, selected characters 106 can be a sequence of characters that have been selected in response to a prompt displayed on a display of the user device. As a more particular example, in some embodiments, the prompt can be a request that the user enter their name, enter a username or password for a user account, and/or enter any other suitable type of information.

Note that, in instances where selected characters 106 correspond to information that is to be privatized (e.g., a password, and/or any other suitable type of information), characters included in selected characters 106 can be presented in any suitable anonymizing manner (e.g., as asterisks, and/or in any other suitable manner).

In some embodiments, each character in selected characters 106 can be selected in any suitable manner. For example, in some embodiments, a character can be selected in response to determining that a particular button on the user device has been pushed. As another example, in some embodiments, the character can be selected in response to determining that a particular selectable input presented in user interface 100 (not shown) has been tapped or clicked. In some embodiments, instructions 108 can provide text that indicates how a character is to be selected. In some embodiments, instructions 108 can be omitted.

Turning to FIG. 1B, an example 150 of a user interface that presents the selected characters is shown in accordance with some embodiments of the disclosed subject matter. In some embodiments, user interface 150 can be presented upon receiving an indication (e.g., based on a determination that a particular button of the user device has been pushed or selected) that the user has finished selecting characters via user interface 100. In some embodiments, user interface 150 can include message 152. In some embodiments, message 152 can include any suitable content, such as a welcome message that includes the characters entered via user interface 100, as shown. In some embodiments, user interface 150 can include any other suitable content, such as a current date and/or time, a menu, and/or any other suitable content.

Turning to FIG. 2, an example 200 of a process for providing input is shown in accordance with some embodiments of the disclosed subject matter.

Process 200 can begin by presenting a user interface for selecting a character at 202. For example, in some embodiments, process 200 can present a user interface similar to user interface 100. In some embodiments, the user interface can indicate characters that are available, and can highlight a particular character from the group of available characters based on a current position or a current movement of the user device, as described below in connection with block 204. Note that, in some embodiments, the available characters presented in the user interface can include any suitable characters, including letters, numbers, punctuation, and/or any other suitable characters. In some embodiments, process 200 can cause the user interface to be presented based on any suitable information. For example, in some embodiments, the user interface can be presented based on a determination that a user wants to enter one or more characters, for example, in response to a prompt to enter information.

Process 200 can receive a first input from an accelerometer at 204. For example, in some embodiments, the first input can indicate that a user of the user device has moved the user device to a particular position, tilted the user device in a particular direction (e.g., to the right, to the left, up, down, and/or in any other suitable direction), and/or moved the user device in a particular direction at a particular speed (e.g., moved the user device to the right at 5 meters per second, and/or any other suitable indication of direction and/or speed). In some embodiments, the first input can be stored in any suitable format. For example, in some embodiments, in instances in which the first input indicates a position of the user device, the position can be indicated in (x, y, z) coordinates, as pitch, roll, and yaw, and/or in any other suitable format. As another example, in instances where the first input indicates a direction a user of the user device has tilted or moved the user device, the direction can be indicated by a vector. In instances where the first input indicates a speed with which a user of the user device moved the user device, the speed can be indicated in any suitable metric of speed (e.g., meters per second, and/or any other suitable speed). Note that, in some embodiments, the first input can indicate any suitable combination of information, such as a direction and a speed, and/or any other suitable combination. Additionally, note that, although process 200 generally describes receiving accelerometer input, in some embodiments, input can be received from any other suitable sensor or input device, such as a magnetometer, a joystick, an eye-tracking device, and/or from any other suitable sensor or input device.

Process 200 can update the user interface based on the first input at 206. For example, in instances where the first input indicates that the user device has been tilted to the left, process 200 can update the user interface to scroll the group of available letters clockwise. As a more particular example, as shown in user interface 100, if the first input indicates that the user device has been tilted to the left, process 200 can cause a character from available characters 104 to become highlighted.

In some embodiments, process 200 can cause the available characters to scroll through more of the available characters in response to determining that the first input indicates that the user device has been moved by a larger amount and/or moved with a faster speed. For example, continuing with the example shown in FIG. 1A, in an instance where the first input indicates that the user device has been tilted by 5 degrees to the right, process 200 can cause the highlighted character to change from “E” to “D,” whereas in an instance where the first input indicates that the user device has been tilted by 10 degrees to the right, process 200 can cause the highlighted character to change from “E” to “D” to “C.” In instances where the first input indicates that the user device has been tilted to the left, process 200 can cause the highlighted letter to become one of the available characters to the right of the highlighted character to become the highlighted character. Additionally or alternatively, in some embodiments, process 200 can cause the user interface to scroll through the available characters at a faster speed in response to determining that the user device has been moved by a larger amount and/or moved with a faster speed. Note that, in some embodiments, process 200 can control the speed of character scrolling by mapping the first input to the group of available characters in any suitable manner. For example, in some embodiments, process 200 can use a direct mapping of a position or angular position of the user device to a character of the group of available characters, a proportional mapping of the position or the angular position of the user device, to a character of the group of available characters, and/or any other suitable type of mapping to select a highlighted character and select a speed with which to scroll through the available characters.

Note that, in some embodiments, process 200 can cause additional characters that were not originally included in the available characters shown in the user interface to be presented. For example, in instances where the available characters shown on the user interface is a subset of a larger group of characters, process 200 can cause additional characters included in the group of characters to be presented in response to the first input. As a more particular example, continuing with the example shown in FIG. 1A, in response to determining that the user device has been tilted to the left, process 200 can cause available character “F” to become the highlighted character, can cause each of the characters shown in user interface 100 to shift to the left, and can cause an additional character to be presented in user interface 100 (e.g., can cause “J” to be presented in the position of “I” in user interface 100, and/or any other suitable character).

In some embodiments, process 200 can loop back to block 204 and can receive another input from the accelerometer. In some embodiments, process 200 can receive input(s) from the accelerometer at any suitable frequency (e.g., ten inputs per second, twenty inputs per second, and/or at any other suitable frequency). In some such embodiments, process 200 can accordingly update the user interface based on the received input(s). Alternatively, in some embodiments, process 200 can update the user interface for a subset of the received input(s). For example, in some embodiments, process 200 can update the user interface in response to determining that two successive inputs from the accelerometer differ by more than a predetermined threshold.

Process 200 can receive a second input for selecting a particular character at 208. For example, in some embodiments, the second input can indicate that the user wants to select the currently highlighted character in the user interface. In some embodiments, the second input can be received in any suitable manner. For example, in some embodiments, the second input can be selection of a particular button on the user device, selection of a particular user interface control (e.g., a push button, and/or any other suitable user interface control) on the user interface, and/or any other suitable type of input. In some embodiments, a manner in which the second input is to be received (e.g., button push, and/or any other suitable type of input) can be indicated on the user interface, for example, as indicated by instructions 108 of FIG. 1A described above. Note that, in some embodiments, process 200 can ignore the second input if it is received within a predetermined duration of time (e.g., within one millisecond, within ten milliseconds, and/or any other suitable duration of time) since the particular character was highlighted at block 206.

Note that, in some embodiments, the second input can be implicit, that is, without user input. For example, in some embodiments, process 200 can determine that a particular character has been selected by determining that the user device has not been moved or rotated for more than a predetermined duration of time (e.g., more than half a second, more than one second, and/or any other suitable duration of time). In some embodiments, process 200 can determine that the particular character is to be selected regardless of a current position of the user device. For example, process 200 can determine that the particular character is to be selected even if the user device is not in a particular neutral position (e.g., 0 degrees of rotation with respect to a particular axis). In some such embodiments, process 200 can determine whether movement of the user device has shifted from a positive velocity to a negative velocity or from a negative velocity to a positive velocity to determine that the particular character is to be selected, based on input from the accelerometer or other input sensor.

Process 200 can update the user interface based on the second input at 210. For example, as shown in FIG. 1A, process 200 can update selected characters 106 to include the selected character.

In some embodiments, process 200 can loop back to block 204 and can receive additional input from the accelerometer, for example, to allow the user to select additional characters.

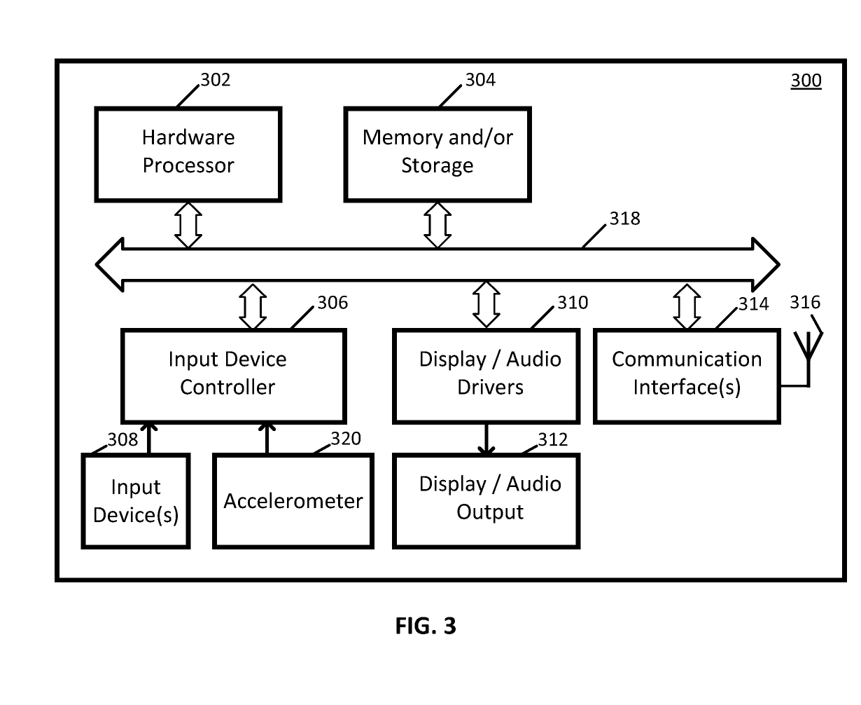

Process 200 can store the selected character at 212. In some embodiments, the character can be stored in any suitable location, such as in a memory as shown in and described below in connection with FIG. 3.

Process 200 can receive a third input indicating that character selection is finished at 214. For example, in instances where characters are selected in response to a prompt for information, the third input can indicate that the user has finished entering information. In some embodiments, the third input can be received in any suitable manner. For example, in some embodiments, the third input can be a selection of a particular button on the user device, selection of a particular user interface control (e.g., a push button, and/or any other suitable user interface control) on the user interface, and/or any other suitable type of input. Note that, in some embodiments, the third input can be implicit, that is, without user input. For example, in instances where information being entered via the user interface corresponds to a fixed number of characters (e.g., four digits of a Personal Identification Number, or PIN), the third input can be received in response to determining that the fixed number of characters have been entered.

Process 200 can update the user interface in response to receiving the third input at 216. For example, in some embodiments, process 200 can cause entered information to be displayed within the user interface. As another example, in some embodiments, process 200 can cause a different user interface to be presented, as shown in and described above in connection with FIG. 1B.

Process 200 can store all of the selected characters at 218. For example, in instances where blocks 204-212 have been repeated to select N (e.g., two, five, ten, and/or any other suitable number) characters, process 200 can store the N characters. In some embodiments, process 200 can store the group of selected characters in association with an identifier indicating the type of information the group of selected characters corresponds to. For example, in instances where the group of selected characters were selected in response to a prompt for a user of the user device to enter their name, the group of selected characters can be stored in association with a “name” or “username” variable. In some embodiments, the characters can be stored in any suitable location, such as in a memory of the user device, as shown in and described below in connection with FIG. 3. Note that, in instances where only one character is entered, process 200 can cause one character to be stored at 218.

In some embodiments, a user device that performs process 200 can be implemented using any suitable hardware. Note that, in some embodiments, the user device can be any suitable type of user device, such as a wearable computer (e.g., a fitness tracker, a watch, a head-mounted computer, and/or any other suitable type of wearable computer), a mobile device (e.g., a mobile phone, a tablet computer, and/or any other suitable type of mobile device), a game controller, and/or any other suitable type of user device. For example, as illustrated in example hardware 300 of FIG. 3, such hardware can include hardware processor 302, memory and/or storage 304, an input device controller 306, an input device 308, display/audio drivers 310, display and audio output circuitry 312, message interface(s) 314, an antenna 316, a bus 318, and an accelerometer 320.

Hardware processor 302 can include any suitable hardware processor, such as a microprocessor, a micro-controller, digital signal processor(s), dedicated logic, and/or any other suitable circuitry for controlling the functioning of a general-purpose computer or a special purpose computer in some embodiments. In some embodiments, hardware processor 302 can be controlled by a computer program stored in memory and/or storage 304 of the user device. For example, the computer program can cause hardware processor 302 to present a user interface for selecting one or more characters, receive input from accelerometer 320, update the user interface based on the user input, and/or perform any other suitable actions.

Memory and/or storage 304 can be any suitable memory and/or storage for storing programs, data, and/or any other suitable information in some embodiments. For example, memory and/or storage 304 can include random access memory, read-only memory, flash memory, hard disk storage, optical media, and/or any other suitable memory.

Input device controller 306 can be any suitable circuitry for controlling and receiving input from one or more input devices 308 in some embodiments. For example, in some embodiments, input device controller 306 can be circuitry for receiving input from accelerometer 320 and/or a magnetometer. As another example, input device controller 306 can be circuitry for receiving input from a touchscreen, from a keyboard, from a mouse, from one or more buttons, from a voice recognition circuit, from a microphone, from a camera, from an optical sensor, from a temperature sensor, from a near field sensor, and/or any other type of input device. In another example, input device controller 306 can be circuitry for receiving input from a head-mountable device (e.g., for presenting virtual reality content or augmented reality content).

Display/audio drivers 310 can be any suitable circuitry for controlling and driving output to one or more display/audio output devices 312 in some embodiments. For example, display/audio drivers 310 can be circuitry for driving a touchscreen, liquid-crystal display (LCD), a flat-panel display, a cathode ray tube display, a projector, a speaker or speakers, and/or any other suitable display and/or presentation devices.

Communication interface(s) 314 can be any suitable circuitry for interfacing with one or more communication networks. For example, interface(s) 314 can include network interface card circuitry, wireless communication circuitry, and/or any other suitable type of communication network circuitry.

Antenna 316 can be any suitable one or more antennas for wirelessly communicating with a communication network in some embodiments. In some embodiments, antenna 316 can be omitted.

Bus 318 can be any suitable mechanism for communicating between two or more components 302, 304, 306, 310, and 314 in some embodiments.

Any other suitable components can be included in hardware 300 in accordance with some embodiments.

In some embodiments, at least some of the above described blocks of the process of FIG. 2 can be executed or performed in any order or sequence not limited to the order and sequence shown in and described in connection with the figure. Also, some of the above blocks of FIG. 2 can be executed or performed substantially simultaneously where appropriate or in parallel to reduce latency and processing times. Additionally or alternatively, some of the above described blocks of the process of FIG. 2 can be omitted.

In some embodiments, any suitable computer readable media can be used for storing instructions for performing the functions and/or processes herein. For example, in some embodiments, computer readable media can be transitory or non-transitory. For example, non-transitory computer readable media can include media such as non-transitory magnetic media (such as hard disks, floppy disks, and/or any other suitable magnetic media), non-transitory optical media (such as compact discs, digital video discs, Blu-ray discs, and/or any other suitable optical media), non-transitory semiconductor media (such as flash memory, electrically programmable read-only memory (EPROM), electrically erasable programmable read-only memory (EEPROM), and/or any other suitable semiconductor media), any suitable media that is not fleeting or devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

Accordingly, methods, systems, and media for providing input based on accelerometer input are provided.

Although the invention has been described and illustrated in the foregoing illustrative embodiments, it is understood that the present disclosure has been made only by way of example, and that numerous changes in the details of implementation of the invention can be made without departing from the spirit and scope of the invention, which is limited only by the claim that follows. Features of the disclosed embodiments can be combined and rearranged in various ways.

What is claimed is:

1. A method for providing input, comprising:
causing a user interface for selecting an item to be presented on a user device, wherein the user interface indicates a group of available items;
receiving a first input from an accelerometer associated with the user device;
updating the user interface based on the first input from the accelerometer to highlight one item from the group of available items;
receiving a second input from the user device indicating that the highlighted item is to be selected;
storing the selected item; and
updating the user interface to indicate the selected item.

2. The method of claim 1, wherein updating the user interface based on the first input from the accelerometer comprises causing items in the group of available items to scroll in a direction based on the input from the accelerometer within the user interface.

3. The method of claim 2, wherein causing items in the group of available items to scroll within the user interface comprises updating the group of available items to include an additional item previously not included in the group of available items.

4. The method of claim 2, wherein a speed at which the group of available items scroll within the user interface is based on the first input from the accelerometer.

5. The method of claim 4, wherein the speed at which the group of available items scroll within the user interface is based on a degree of motion corresponding to the first input from the accelerometer.

6. The method of claim 1, wherein the second input from the user device is received via a button on the user device.

7. A system for providing input, the system comprising:
a memory; and
a hardware processor coupled to the memory that is configured to:
cause a user interface for selecting an item to be presented on a user device, wherein the user interface indicates a group of available items;
receive a first input from an accelerometer associated with the user device;
update the user interface based on the first input from the accelerometer to highlight one item from the group of available items;
receive a second input from the user device indicating that the highlighted item is to be selected;
store the selected item; and
update the user interface to indicate the selected item.

8. The system of claim 7, wherein updating the user interface based on the first input from the accelerometer comprises causing items in the group of available items to scroll in a direction based on the input from the accelerometer within the user interface.

9. The system of claim 8, wherein causing items in the group of available items to scroll within the user interface comprises updating the group of available items to include an additional item previously not included in the group of available items.

10. The system of claim 8, wherein a speed at which the group of available items scroll within the user interface is based on the first input from the accelerometer.

11. The system of claim 10, wherein the speed at which the group of available items scroll within the user interface is based on a degree of motion corresponding to the first input from the accelerometer.

12. The system of claim 7, wherein the second input from the user device is received via a button on the user device.

13. A non-transitory computer-readable medium containing computer executable instructions that, when executed by a processor, cause the processor to perform a method for providing input, the method comprising:
causing a user interface for selecting an item to be presented on a user device, wherein the user interface indicates a group of available items;
receiving a first input from an accelerometer associated with the user device;
updating the user interface based on the first input from the accelerometer to highlight one item from the group of available items;
receiving a second input from the user device indicating that the highlighted item is to be selected;
storing the selected item; and
updating the user interface to indicate the selected item.

14. The non-transitory computer-readable medium of claim 13, wherein updating the user interface based on the first input from the accelerometer comprises causing items in the group of available items to scroll in a direction based on the input from the accelerometer within the user interface.

15. The non-transitory computer-readable medium of claim 14, wherein causing items in the group of available items to scroll within the user interface comprises updating the group of available items to include an additional item previously not included in the group of available items.

16. The non-transitory computer-readable medium of claim 14, wherein a speed at which the group of available items scroll within the user interface is based on the first input from the accelerometer.

17. The non-transitory computer-readable medium of claim 16, wherein the speed at which the group of available items scroll within the user interface is based on a degree of motion corresponding to the first input from the accelerometer.

18. The non-transitory computer-readable medium of claim 13, wherein the second input from the user device is received via a button on the user device.
